(19) United States
(12) Patent Application Publication
(10) Pub. No.: US 2018/0313049 A1
(43) Pub. Date: Nov. 1, 2018

(54) IN-POND WATER QUALITY MAINTENANCE SYSTEM

(71) Applicant: DIAMOND MANUFACTURING INC, TYGH VALLEY, OR (US)

(72) Inventor: Anthony L. Morelli, Tygh Valley, OR (US)

(21) Appl. No.: 15/963,956

(22) Filed: Apr. 26, 2018

Related U.S. Application Data
(60) Provisional application No. 62/490,491, filed on Apr. 26, 2017.

(51) Int. Cl. E02B 15/10; C02F 1/40; C02F 1/00; B01D 29/11; B01D 29/90; E02B 15/04

(52) U.S. Cl. CPC E02B 15/106; C02F 1/40; C02F 1/004; C02F 2103/007; B01D 29/902; E02B 15/04; B01D 29/11

(57) ABSTRACT

Examples are disclosed herein that relate to an in-pond water quality maintenance system. One example provides a pond water quality maintenance system, including a skimmer basin configured to collect pond surface debris, the skimmer basin including an upper opening configured to permit a flow of water and debris from a pond surface into the skimmer basin, a strainer basket positioned within the skimmer basin and configured to trap at least some of the debris that enters the skimmer basin through the upper opening, a skimmer pump positioned within the skimmer basin below the strainer basket, the skimmer pump configured to draw water through the strainer basket and to pump the water out of the skimmer basin, and one or more lower openings configured to permit a flow of water into the skimmer basin from a pond depth below the strainer basket.

### CROSS-REFERENCE TO RELATED APPLICATIONS

This application claims the benefit of U.S. Provisional Patent Application No. 62/490,491, filed Apr. 26, 2017, and entitled “In-Pond Water Quality Maintenance System”, the complete contents of which are hereby incorporated herein by reference for all purposes.

### BACKGROUND

Ornamental pond and water features utilize various systems to help maintain water quality. For example, skimmers may be utilized to remove surface debris and filter water in the pond. Water drawn through the skimmer via a pump may be recirculated back into the pond, for example via a waterfall feature, to oxygenate the water and help prevent stagnation.

### SUMMARY

Examples are disclosed herein that relate to pond water quality maintenance systems. One example provides a pond water quality maintenance system including a skimmer basin configured to collect pond surface debris. The skimmer basin includes an upper opening configured to permit a flow of water and debris from a pond surface into the skimmer basin, a strainer basket positioned within the skimmer basin and configured to trap at least some debris that enters the skimmer basin through the upper opening, a skimmer pump positioned within the skimmer basin below the strainer basket, the skimmer pump configured to draw water through the strainer basket and to pump the water out of the skimmer basin, and one or more lower openings configured to permit a flow of water into the skimmer basin from a pond depth below the strainer basket.

### BRIEF DESCRIPTION OF THE DRAWINGS

FIG. 1 shows an example pond water quality maintenance system.

FIG. 2 shows an example skimmer basin.

FIG. 3 shows a cutaway view of the example skimmer basin of FIG. 2.

FIG. 4 shows an exploded view of the skimmer basin of FIG. 2.

FIG. 5 shows an interior view of the skimmer basin of FIG. 2.

FIG. 6 shows an example strainer basket.

FIG. 7 shows an example pump installed inside a skimmer basin.

FIG. 8 shows an example float valve coupled to an outside of a skimmer basin.

FIG. 9 shows an example filter basin and example inflow component coupled to the outside of the filter basin.

FIG. 10 shows an example flow distributor coupled to the inside of the filter basin of FIG. 9.

FIG. 11 shows an example cleanout scenario for cleaning a filter basin.

FIG. 12 shows an example configuration of a pump installed in a filter basin.

FIG. 13 shows an example plugged configuration for an inlet of the inflow component of a filter basin.

FIG. 14 shows an example pondless water feature.

FIG. 15A shows another example filter basin configuration.

FIG. 15B shows the filter basin of FIG. 15A configured as an example pondless filter pump basin.

FIGS. 16A and 16B show another example skimmer basin.

FIG. 17 shows another example skimmer basin.

FIGS. 18A and 18B show an additional example filter basin.

FIGS. 19A and 19B show an example sump pump basin.

FIGS. 20A and 20B show another example pondless filter pump basin.

### DETAILED DESCRIPTION

A pond skimmer utilizes a pump that draws water from the surface of the pond into an interior of a basin, through a strainer basket that traps debris, through a filter stage, and cycles the filtered water back into the pond. As skimmers draw and recirculate surface water, little circulation may be provided to lower regions of the pond. Also, at times, accumulated debris in the strainer basket may restrict water flow into the skimmer basin and pump, which may cause the skimmer pump to cavitate due to insufficient water flow, potentially damaging the pump. Pump cavitation as used herein refers to bubbles or cavities forming at the impeller of the pump due to insufficient water flow. As such, skimmers may require frequent cleaning. However, cleaning a skimmer may also be challenging, as it may be difficult to access and remove the strainer basket, depending upon the pond configuration. Further, conventional ponds may include a biofalls that may often become flow restrictive, forcing water around the filtration systems and preventing filtering, resulting in only a trickle of water at the biofalls.

Further, conventional skimmer installations may compromise the integrity of a pond liner. For example, the intake and filter of a skimmer may be located within a liner of the pond, while the pump may be located outside of the pond. As such, the liner may be cut during installation to allow the in-pond components to be connected to the out-of-pond components via a tube passing through the liner, and then sealed once this connection is made. This seal between the liner and the skimmer system may be compromised over time, resulting in water leakage.

Accordingly, examples are disclosed that relate to in-pond water quality maintenance systems that may help to avoid these and potentially other problems with conventional systems. As described in more detail below, the disclosed examples may be used in ornamental ponds and in “pondless” water features such as ornamental waterfalls and fountains with concealed basins. Some examples include a first water recirculation path having a skimmer basin positioned within a pond near a surface of the pond. The skimmer basin includes a pump positioned within an interior of skimmer basin, such that the entire skimmer system may be installed within an interior of a pond lining without cutting the lining, thereby helping to prevent leaks. The skimmer basin has an open top with a flange that allows the skimmer structure to be easily concealed with rocks or other ornamental features, and that permits convenient cleaning of the strainer basket without removal of the basket. Further, the skimmer basin includes openings formed at a location below the strainer basket to allow water to be drawn into the pump even when the strainer basket becomes clogged. This may help reduce the risk of pump cavitation and resulting damage, and also does not restrict outflow and recirculation to another portion of the pond (e.g. an upper pool or waterfall). The outlet from the skimmer pump may be connected via a hose to another portion of the pond to promote pond circulation.

Some examples also may include a second recirculation path that includes a second pump disposed at a deeper location within the pond, such as at a sump area of the pond, to help circulate pond bottom water. The sump pump may be connected via a hose to a filter basin located within the pond, for example, at a location near the surface of the pond. The sump pump is configured to pump water from the bottom of the pond to the filter basin. The filter basin is used to pump sump water through a filter media, e.g. rock media, that provides mechanical and/or biological filtration, and then pump the filtered water out of the filter basin (e.g. through an outflow located at a top of the filter basin) to recirculate back into the pond. The filter basin may also be used as an in-pond planter. Together, the skimmer basin, filter basin and sump pump may provide continuous water cycling and filtering of pond water from all depths of the pond, as opposed to conventional skimmer systems that mainly filter and recirculate surface water. Such water circulation may be conducive to the growth of beneficial bacteria and a healthy pond ecosystem, and may provide improved water clarity and quality with lower maintenance requirements.

The disclosed examples further include features that allow the system components to be more easily cleaned and maintained compared to conventional water quality maintenance systems. For example, the skimmer basin may include a top opening that allows a person to simply visually inspect and reach in through the top opening to collect and remove any accumulated debris that sits atop the strainer basket, without requiring removal of the strainer basket. Additionally, the filter basin may include a bypass valve and a recirculation outlet that allows for clean-outs and/or pump-downs by shutting off the bypass valve, and attaching a clean-out hose to the recirculation outlet.

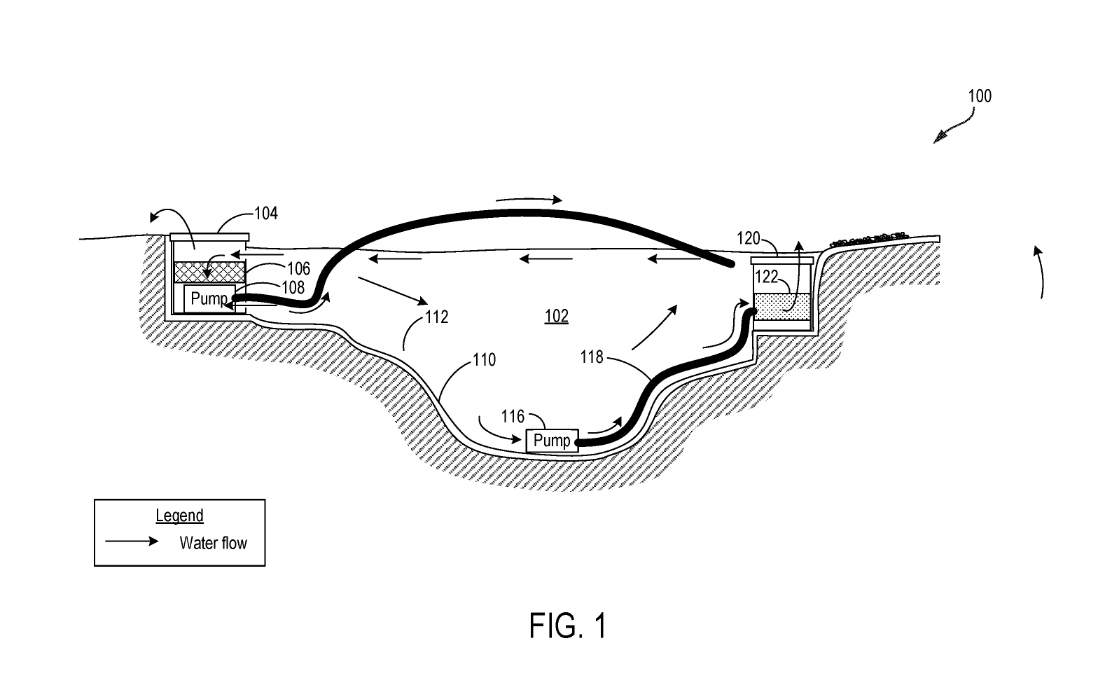

FIG. 1 schematically shows an example in-pond water quality maintenance system 100 installed in a pond 102. In a first recirculation path, the system 100 includes a skimmer basin 104 having a strainer basket 106 and pump 108 configured to draw pond water into the skimmer basin 104 via an upper opening of the skimmer basin 104. As the pump 108 draws water through the strainer basket 106, the strainer basket 106 may catch at least some debris in the water, such plant matter, algae, insects, fish waste, etc. The skimmer basin 104 may also have one or more lower openings formed in the side of the skimmer basin 104, allowing water to flow into the skimmer basin 104 simultaneously from a pond depth below the strainer basket 106 and from the upper opening above the strainer basket 106. As the strainer basket 106 accumulates debris and begins to restrict water flow, the one or more lower openings allows sufficient water to flow into a lower portion of the skimmer basin 104 to avoid pump cavitation. Examples of the upper opening, lower openings, strainer basket and various other features of the skimmer basin are described in more detail below.

As shown, the skimmer basin 104 is configured to rest atop a shelf in the pond and remains fully inside a liner 110 that lines the pond 102, and as such does not require forming an opening through the liner for installation. This provides for convenient installation and helps to eliminates liner leakage concerns arising from conventional skimmer basin installations. In some examples, the skimmer basin 104 may be fit and bedded onto a skimmer shelf inside the pond 102 before the underlayment and liner 110 are installed, and then removed for installation of the liner 110 and re-inserted back over the liner 110 afterward. This may allow for any adjustments in overall water level and final leveling of the skimmer basin 104. Further, in some examples, the skimmer basin 104 may be installed such that the water level is 2-3 inches below the skimmer basin's top flange. In other examples, the skimmer basin may be installed in any other suitable configuration.

In some examples, the skimmer pump 108 outlet may be connected to a hose that leads to another area of the pond. In FIG. 1, the water filtered by the skimmer 104 is directed via hose 112 to an opposite side of the pond 102. It will be understood that in other examples, an upper pool and/or waterfall basin may be included and feed a waterfall feature and the hose 112 may lead to such an upper pool area in such examples

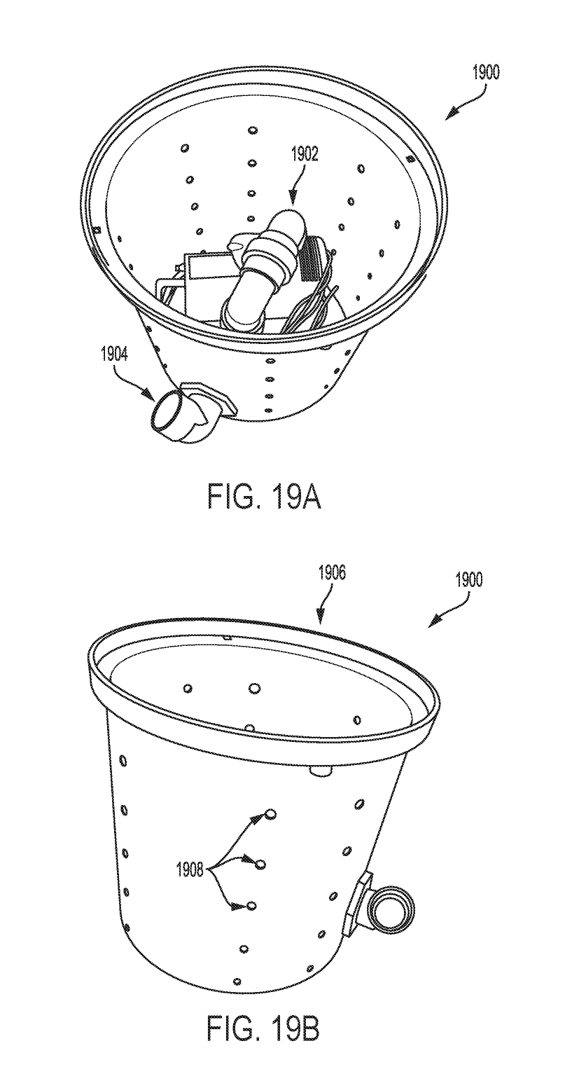

Continuing with FIG. 1, in a second recirculation path, the system 100 includes a sump pump 116 disposed in a relatively deeper area of the pond 102. The sump pump 116 intakes water from the relatively deeper area of the pond 102 and pumps the water via a hose 118 to a connected filter basin 120 installed in a shelf in the pond in a similar fashion as the skimmer basin 104. The sump pump 116 thus helps to circulate water from the bottom of the pond 102, which may contain a high amount of settled debris, such as concentrates of nutrients and gases from organic material breakdown, excess fish food, dead algae, etc. In some examples, the sump pump 116 may be housed inside a basin or other suitable housing, as will be described with regard to FIGS. 19A and 19B. The filter basin 120 contains filter media 122 through which water moves, thereby filtering the water received from the sump pump 116. The filter media 122 may provide finer mechanical filtration than provided by the skimmer strainer basket 106, and/or biological filtration as described above with regard to the water basin 114. In addition to filtering particulate matter from the water, the filter basin 120 also may feed colonized aerobic bacteria with the nutrients received from the sump area of the pond and help to reduce algae growth in the pond, which may improve water quality and clarity, and overall ecosystem health. After filtering, the water then outflows from a top opening of the filter basin 120 back into the pond. An example filter basin is described in more detail below.

The filter basin 120 may be installed similarly to the skimmer basin 104 by bedding the filter basin 120 along the pond edge, except the top may be set and leveled such that the top is located below the water surface, such as 0.5-3 inches below the water surface. The sump pump 116 may be placed in a suitably deep location within the pond, and plumbed with a hose to the filter basin 120. The filter basin 120 may be camouflaged by rocks, and may be cleaned in a convenient manner without removal from the pond, as described in more detail below.

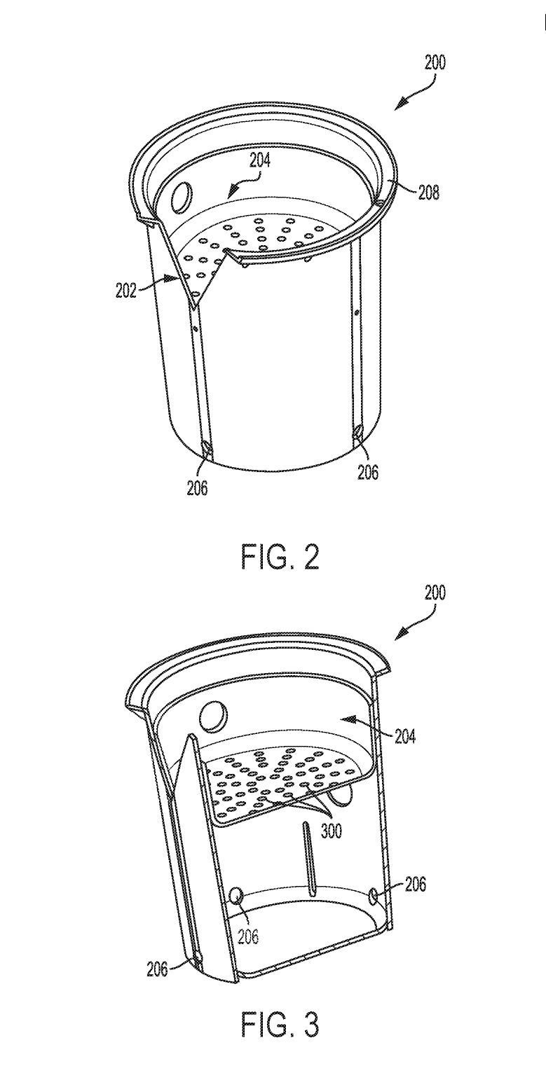

FIG. 2 shows an example skimmer basin 200. The skimmer basin 200 has an upper opening 202 through which water is drawn. The upper opening 202 is shown as a V-shaped notch formed in the side at the top of the skimmer basin 200, as an example. A V-shape or triangular shape may help to break the surface of the water in a manner that allows water to efficiently flow into the skimmer basin 200. The size of the V-shaped opening may help to cause water inflow from a larger surface area of the pond compared to other openings. As a non-limiting example, the opening may be approximately 6.5 to 7.5 inches in height in a direction normal from the bottom vertex of the V to the top of the skimmer basin, and 6.5 to 7.5 inches in width directly across a top of the V-shaped opening, in a skimmer basin of dimensions 22 inches tall by 18 inches inner diameter at the top. However, it will be understood that the upper opening 202 may have any other suitable shape that allows a sufficient inflow of water to effectively skim surface water in the pond.

When installed in a pond, the skimmer basin 200 may be positioned such that a top of the skimmer basin is above the water line, e.g. by 2-3 inches, while the remainder of the skimmer basin lies beneath the water line. The upper opening 202 may be formed such that at least a portion of the upper opening 202 is disposed below the water line, allowing inflow of water through the upper opening 202. The flow of water pulls surface debris into a strainer basket 204 inside the skimmer basin 200, thereby skimming the surface debris from the pond. As described above, water may be drawn through via a pump (not shown) housed inside the skimmer basin 200 and disposed beneath the strainer basket 204.

Also beneath the strainer basket 204 are lower openings 206 formed in the side of the skimmer basin 200. The lower openings 206 are located to allow the flow of water into the skimmer basin 200 from a depth below the strainer basket 204. As mentioned above, as the strainer basket 204 becomes full of debris, it may restrict water flow into the pump area of the skimmer basin via the upper opening 202. Thus, the lower openings 206 may allow sufficient water to flow into the lower portion of the basin 200 to prevent the water level in the pump area of the skimmer basin from falling beneath the pump intake. This may help to prevent the pump from pulling in air, and thus may help to prevent damage to the pump from cavitation, allowing water circulation to continue uninterrupted. The lower openings 206 may be sized based upon a pumping capacity of the pump and/or the size of the upper V-shaped opening 202. For example, the sizes of lower openings 206, the pumping capacity of the pump, and the size of the upper opening 202 may all be “matched” to one another such that even when the strainer basket 204 is fully clogged, water may still flow in via lower openings 206 at the volume flow rate of the pump. In one example configuration, four lower openings may be formed near the bottom of the skimmer basin 200, each lower opening being approximately 1.25 inches in diameter.

The skimmer basin 200 has a flange 208 extending outwardly from a top of the skimmer basin 200. The flange 208 provides a surface that allows the placement of rocks around the rim of the skimmer basin 200, in order to provide natural camouflage of the skimmer basin 200. The debris trapped by the strainer basket 204 may be easily removed, as the open top of the skimmer basin 200 allows a person to simply reach in with a hand or tool to reach the debris, without requiring removal of the strainer basket 204 itself In some examples, the strainer basket 204 may be configured with a pull rope or chain for easy removal if desired. In other examples, two opposing holes in the strainer basket wall may serve as finger tip handles for easy removal.

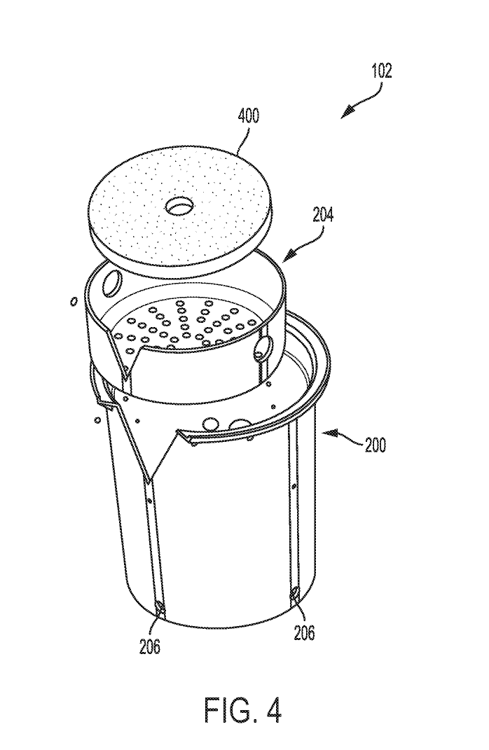

FIG. 3 shows a cutaway view of the skimmer basin 200. The strainer basket 204 comprises a plurality of filter openings 300, which allow water to flow through while trapping debris particles larger than the filter openings 300. FIG. 4 shows an exploded view of the skimmer basin 200. In some examples, an optional collection pad 400 may be placed in the strainer basket 204, which may help to further collect debris, and may simplify a cleaning process by allowing a person to remove the collection pad 400 for disposal of debris.

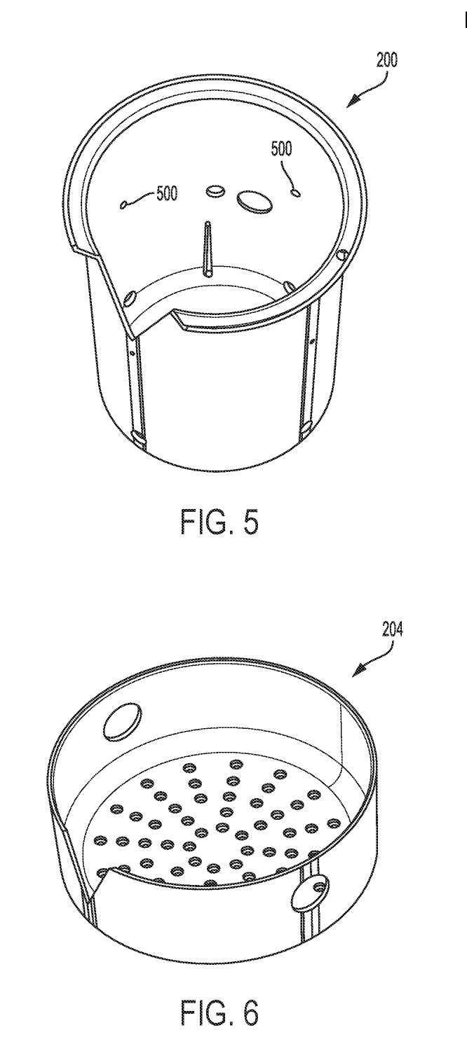

FIG. 5 shows an interior view of the skimmer basin 200 without the strainer basket 204. The skimmer basin 200 comprises supporting elements 500 positioned on an interior side of the skimmer basin 200. The supporting elements 500 may take the form of screws, bolts, one or more molded plastic shelves, plastic tabs or any other suitable form that supports the strainer basket 204 when it is inserted inside the skimmer basin 200. FIG. 6 shows a perspective view of the strainer basket 204.

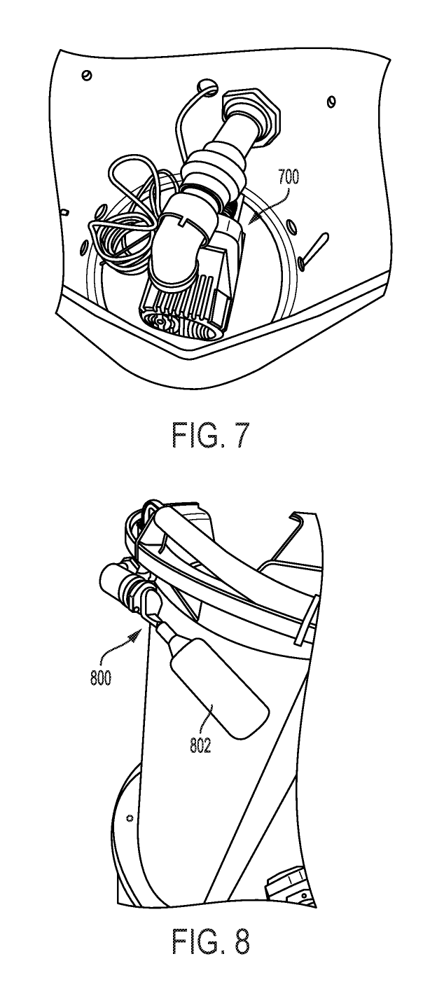

FIG. 7 shows an example pump 700 installed inside a skimmer basin. Any suitable pump configured to be located under water may be used. In some examples, the pump 700 may be configured to pump at a rate of approximately 5000 gallons per hour (GPH). Further, a pump screen (not shown) may be placed an intake of the pump 700 to prevent any inside of debris that may have been missed by the strainer basket may be further filtered before reaching the pump intake. The pump screen may take the form of a mesh bag filled with media, such as rocks, in some examples. A second pump screen may also be located around the pump intake of the sump pump of the system. In other examples, any other suitable pump and/or screen configurations may be used.

FIG. 8 shows an example float valve 800 coupled to an outside of a skimmer basin. The float valve is configured to turn a pond fill water line on or off, depending upon whether a float 802 of the float valve 800 is respectively at a lower or higher position. The coupling may include a range of adjustment (e.g. a threaded twist connection) that allows the water level to be easily adjusted. Locating the float valve outside of the skimmer basin may allow for more accurate control of the pond fill level than locating the float valve inside of the skimmer basin, and further may provide for easier access in case repair or replacement is needed. The skimmer basin may also have a corresponding water flow adjustment valve (a “tuner” valve) that allows control of water flow and water volume within a range based upon pump capacity, fitting and hose dimensions, and/or other parameters. The adjustment valve (not shown) may be located at any suitable location along a path of the outflow from the skimmer basin. For example, the adjustment valve may be attached to an outside of the skimmer basin to provide for easy access and hiding. The adjustment valve may be configured to allow a one-time water flow setting during pond setup, or may allow readjustment of water flow as desired, in various examples. The adjustment valve may open to divert water flow from a waterfall or other water feature without reducing a rate of water intake or output, as compared to conventional systems that may slow the intake at the pump by valving the output.

In other examples, the skimmer basin with a V-shaped opening may be re-purposed as a stand-alone skimmer filter basin. The skimmer basin may be used as a skimmer filter basin in smaller ponds, pondless water features or fountains, or water columns, as examples. In some examples, filter media, such as rocks, may surround the lower openings (e.g. lower openings 206) inside the skimmer filter basin, such that in addition to being skimmed, water flowing inside the skimmer filter basin may be filtered by the filter media. In a pondless feature, filter media may be placed atop of the skimmer filter basin, providing camouflage while still allowing the float valve (e.g. 800) to operate.

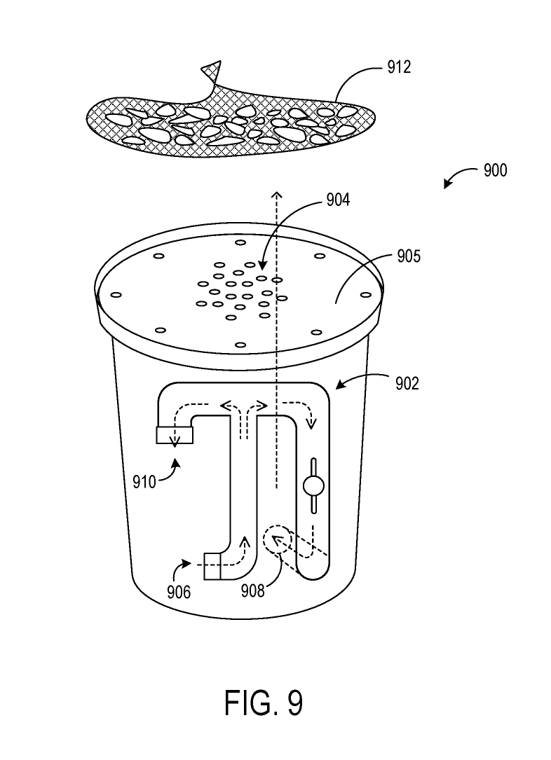

FIG. 9 schematically shows an example filter basin 900. The filter basin 900 includes an inflow component 902, and at least one outflow opening 904 at a top of the filter basin 900. In the depicted examples, the outflow openings 904 are formed in a lid 905 of the filter basin 900, but may have any other suitable configuration in other examples. In other examples, there may be no lid and instead water may flow up out of the open top of the filter basin 900. The filter basin 900 may further include a plurality of side openings 906 formed in the basin wall. When the filter basin 900 is placed within the pond, e.g. one-half to three inches beneath water level, the static water pressure provided by the pond water may exceed the dynamic water pressure of water within the filter basin 900, which allows water to flow in an upward direction through the filter basin 900 and out through outflow openings 904.

The inflow component 902 comprises various plumbing components coupled to an outside of the filter basin 900 and that are in fluid communication with an inside volume of the filter basin 900. The inflow component 902 includes an inlet 907 located outside of the filter basin 900 that is configured to receive pond water pumped by an in-pond pump, and an outlet 908 positioned inside the filter basin 900 at a lower location in the filter basin 900 than the outflow opening 904. The inverted 90-degree fitting of the outlet 908 and positioning of the outlet 908 above the basin floor by one to one-half an inch may help to disperse incoming water in all directions, helping water to efficiently flow through the full filter area. The inflow component 902 further includes a bypass outlet 910 positioned outside of the filter basin 900 to permit a portion of water received via the inlet 907 to bypass the filter basin 900. The bypass outlet 910 may allow a pump with a relatively high capacity to be used while ensuring continuous flow throughout the inflow component 902. The bypass outlet 910 may also be attached to a hose such that some of the nutrient rich pond water may be diverted to an aquaponics farm system via the bypass outlet and hose.

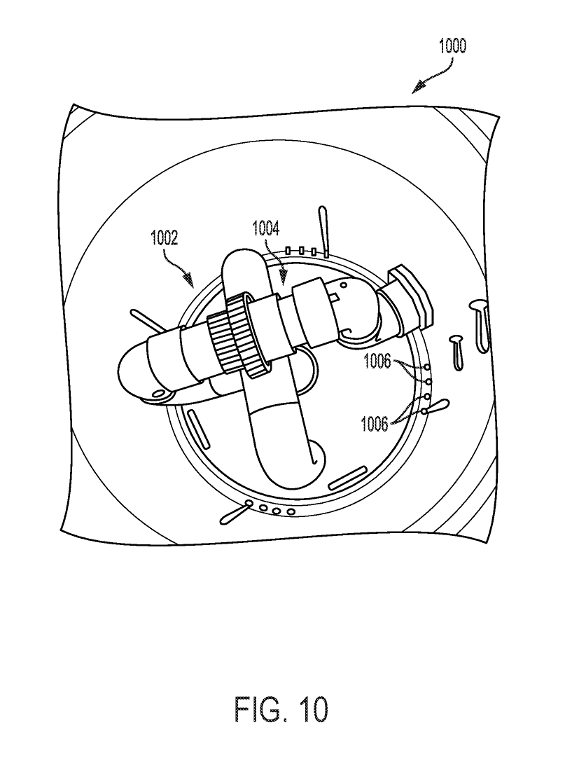

Water flowing inside the filter basin 900 from inflow component 902 may be filtered by filter media inside the filter basin 900, as will be described in more detail with regard to FIG. 10. Also, a mesh bag 912 of additional filter media (e.g. rocks, such as cinder or lava rocks, or any other suitable rocks or other material(s)) may be placed atop of and covering the lid 905 such that water leaving the filter basin passes through the rocks. The rocks also may provide natural camouflage of the filter basin 900. The lid 905 may be removable to reveal the interior of the filter basin 900, for cleaning, servicing, etc.

FIG. 10 shows an example filter basin 1000 and a flow distributor 1002 coupled to and outlet 1004 of the inflow component (not shown in FIG. 10) inside of the filter basin 1000. The depicted flow distributor 1002 has a T-shaped configuration to distribute water inside of the filter basin 1000, but may have any other suitable configuration in other examples. The filter basin 1000 may also have a plurality of lower openings 1006 as shown to allow for drainage during cleanout, as will be described below in more detail. Similar to FIG. 9, when the pond is filled, the water level may be one-half to three inches over the open top of the filter basin 1000, and the static pond water pressure may equalize the dynamic water pressure in the filter basin 1000, causing water inside to flow out of the open top of the filter basin 1000, rather than out through the lower openings 1006 at the bottom of the filter basin 1000.

As water received from the sump pump flows inside the filter basin 1000 via the outlet 1004 of the inflow component, the water may be filtered by filter media (not shown) filling the filter basin 1000. Examples of filter media that may be used includes filter mats, filter pads, filter media bags, biofilter balls, etc. As one example, cinder rocks may be used between ⅝ of an inch to ¾ of an inch wide. As mentioned above, the filter media may simultaneously filter the water and provide nutrients for colonizing aerobic bacteria, which may help to control the amount of algae growth in the pond.

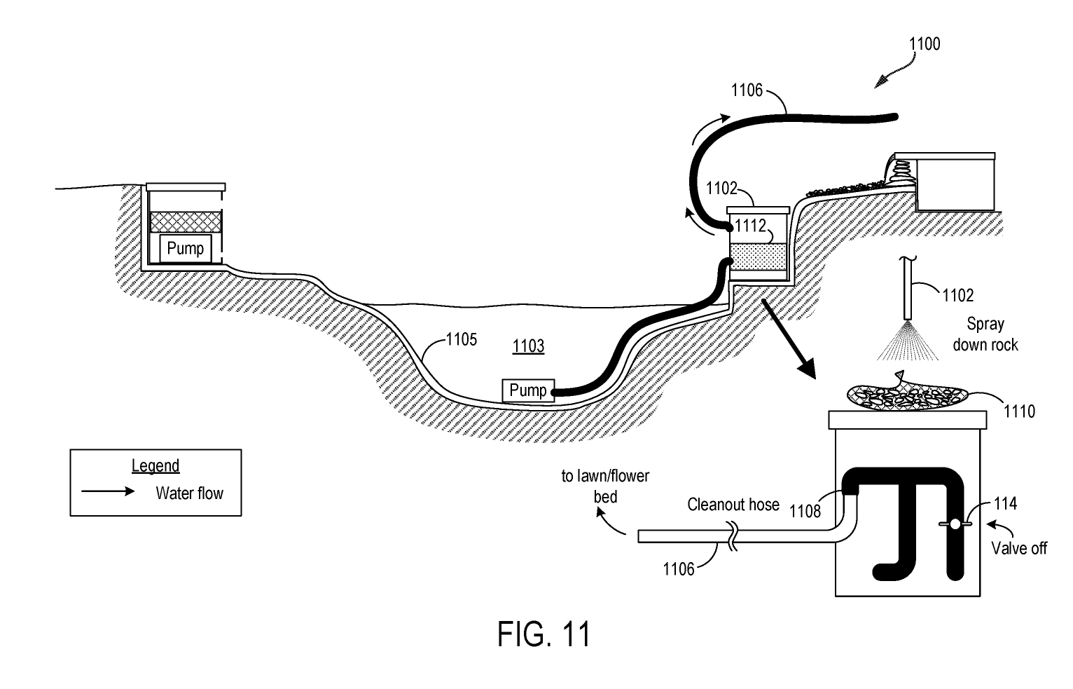

The filter basin may be cleaned without removal from the pond by back-rinsing through the filter media, e.g. with a freshwater or garden hose. FIG. 11 shows an example cleanout scenario 1100 for cleaning out a filter basin 1102. First, preparation for back-rinsing is performed by draining the pond 1103, which may include closing bypass valve 1104 of the filter basin 1102 and pumping water out of the pond. Water inside the filter basin 1102 may then be pumped out via an attached cleanout hose 1106 to a recirculation outlet 1108, e.g. to a surrounding lawn, garden, or flower bed, as opposed to during normal operation when the recirculation outlet 1108 may also be used to circulate nutrient rich water in the pond and/or up to any aquaponics grow stations, greenhouses, or grow kits for herbs, vegetables, etc. The liner 1105 and rock of the pond may be rinsed down and cleaned using a hose during this pump down. Next, cleanout of the filter basin 1102 may be performed while the bypass valve 1104 is shut off, and attaching a cleanout hose 1106 to a recirculation outlet 1108 of the filter basin 1102. The filter basin 1102 is then ready for back rinsing with the garden hose. During rinsing, water may drain out through lower openings 1006. The lower openings 1006 may also be used to spray freshwater into the filter basin 1102 for thorough rinsing. Cleaning of filter basins may be needed only once every one to three years, taking about three to five hours for the whole pond cleanout process.

The pump screen media from both the skimmer pump and the sump pump may also be cleaned by simply rinsing the pump screen media and placing them back around the pumps. To clean the skimmer and sump pumps, both pumps may be tethered to cords such that the pumps may be easily pulled out for inspection and cleaning. Water may be sprayed into the impeller to clear any debris, if present.

The water quality maintenance system features as described herein allow for algaecide and beneficial bacteria treatments to be added at the surface skimmer basin during normal pond operation without destroying pre-existing aerobic bacteria. This may be accomplished by not pumping the algaecide directly through the filter media in the system. The algaecide treatment may be added first, then the beneficial bacteria treatment after waiting for a suitable amount of time (for example, two days) to allow for the algaecide treatment to work. This process may be performed by bypassing the sump filter, e.g. by shutting off the sump pump, for two days during the algaecide treatments. This may help to improve water quality and clarity in an inexpensive manner. In contrast, conventional skimmers and waterfall systems pump the algaecide through the filter media, which may destroy the beneficial bacteria necessary for healthy pond ecosystems, and may thus often require expensive water eco-treatments.

The system as described herein also may allow the use of relatively larger rocks e.g. 3-6 inches in size, to anchor, secure, and camouflage each in-pond system component. Lining the pond with such a size of rock covers the liner yet allows for circulation around the rocks to help aerobic bacteria proliferate, as opposed to conventional pond systems that use tiny or small rocks layered onto horizontal shelves in the pond. In such small rock settings, the rocks provide an oxygen-deprived environment with little to no water flow, creating instead an anaerobic bacteria environment which may be destructive to the pond ecosystem. Layered small rock may also make it very difficult to clean the rocks with spraying the rocks all about.

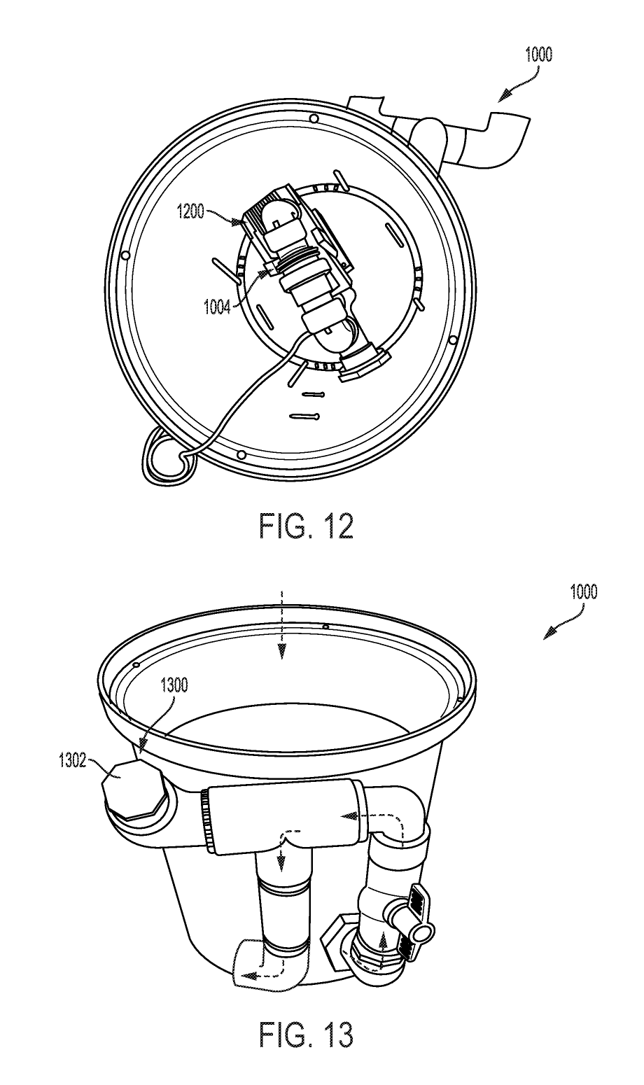

In some examples, the filter basin as disclosed herein may be used to house a pump and act as a filter pump basin for a pondless water feature, such as a waterfall or fountain without a pond. Returning to FIG. 10, the flow distributor 1002 is configured to be removable from the outlet 1004. Once removed, the outlet 1004 may be attached to a pump. FIG. 12 shows an example configuration of a pondless filter pump basin where a pump 1200 is attached to the outlet 1004 of the filter basin 1000. On the outside, an inlet 1300 of the inflow component on the filter basin 1000 may be blocked with a plug 1302, as shown in FIG. 13. In other examples, the inlet 1300 may be blocked off by shutting off a valve. Dotted arrows show a path in which water may flow when filter basin 1000 is used as a pump filter, where water may be drawn in through a top of the filter basin 1000 via openings in the lid, and flow in a reverse direction through the inflow component. A lid covering the filter basin 1000, when included, may also have two additional openings, one for the float valve auto-fill and one for the pump cord.

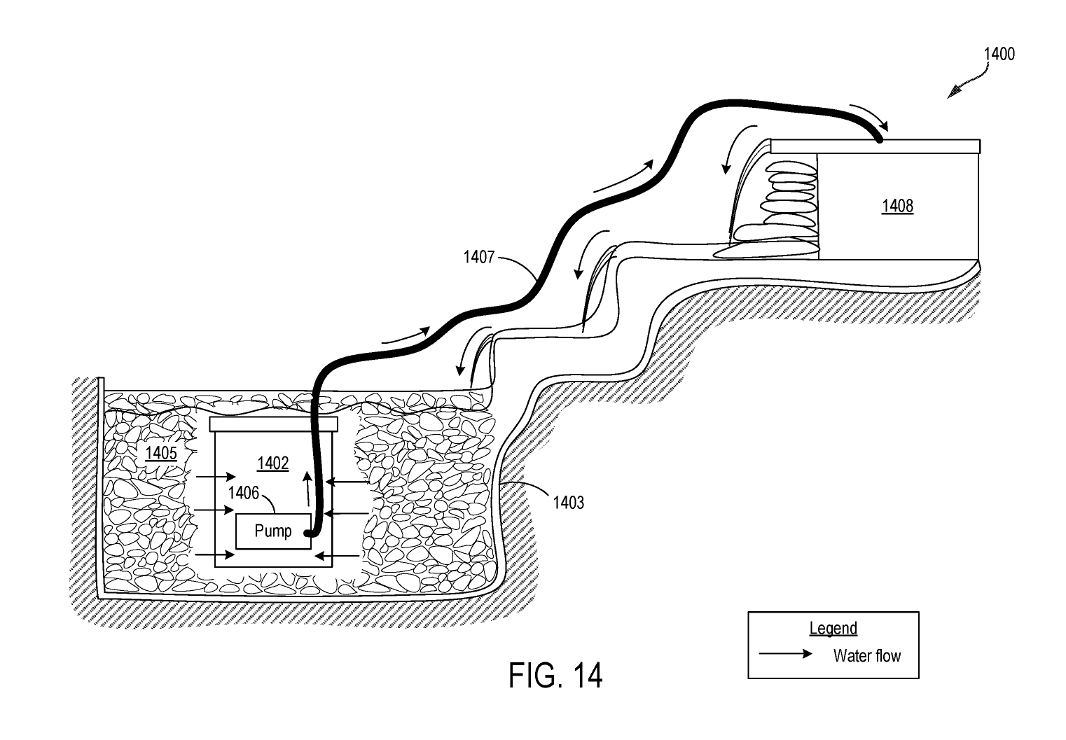

FIG. 14 schematically shows an example pondless water feature 1400 (a waterfall) and filtration system. A pondless filter pump basin 1402 is installed in an area 1405 under water level with surrounding rocks covering to the top of the pump filter basin 1402 for camouflage. The filter pump basin 1402 may be installed within a liner 1403 at a bottom of the waterfall 1400 that may receive water accumulated in the area 1405, which collects the water trickled down from the waterfall 1400. Water may filter through the rocks outside of the filter pump basin 1402 before being drawn in to the filter pump basin 1402 via one or more openings in a side of the filter pump basin 1402. A pump 1406 inside the filter pump basin 1402 pumps the water out through a hose 1407 that is connected to the pump outlet, and the hose extends up to a waterfall basin 1408. Water then falls down from the waterfall basin 1408, via the waterfall in this example, for recollection at the bottom by the filter pump basin 1402. It will be understood that the filter pump basin may be similarly installed for use in any other suitable pondless water features, including fountains, water columns, bird baths, small streams, etc.

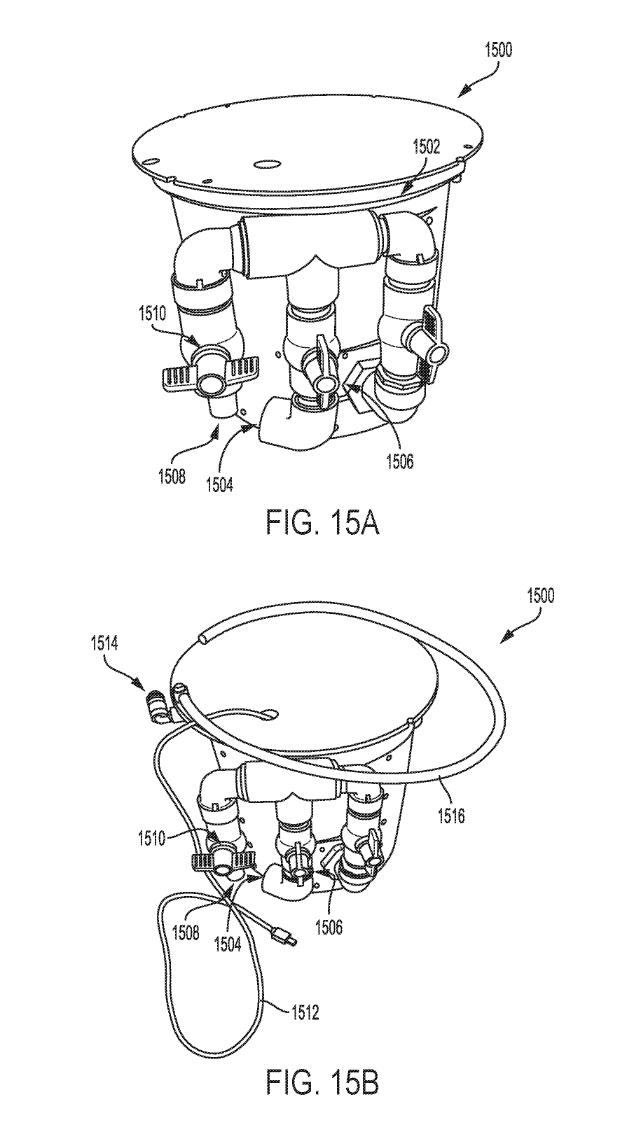

FIG. 15A shows another example filter basin 1500 and a different example configuration of an inflow component 1502 coupled to the outside of the filter basin 1500. Similarly to FIG. 9, the inflow component 1502 includes an inlet 1504 located outside of the filter basin 1500 that is configured to receive pond water, and an outlet (not visible) positioned inside the filter basin 1500. In this example, the inlet 1504 may be configured such that the filter basin 1500 may be converted to a pondless filter pump basin. The inflow component 1502 also includes a bypass outlet 1508 that also has a corresponding valve 1510 to block off or allow a flow of water through the bypass outlet 1508.

FIG. 15B shows the filter basin 1500 converted to a pondless filter pump basin configuration for use in a pondless water feature. The filter pump basin configuration includes a pump installed inside the filter basin 1500, with a visible pump cord 1512. The filter pump basin configuration further includes an attachable float valve 1514 on the lid or basin 1500 with an opening in the basin 1500 to accommodate a float valve supply hose 1516 to connect to the float valve 1514, similar to that described with regard to FIG. 8. Further, a different hose (e.g. garden hose) may be attachable to a recirculation outlet 1504 for directing a portion of pumped water to an upper area (e.g. upper pool, top of a fountain or column rock, waterfall basin) in a pondless water feature.

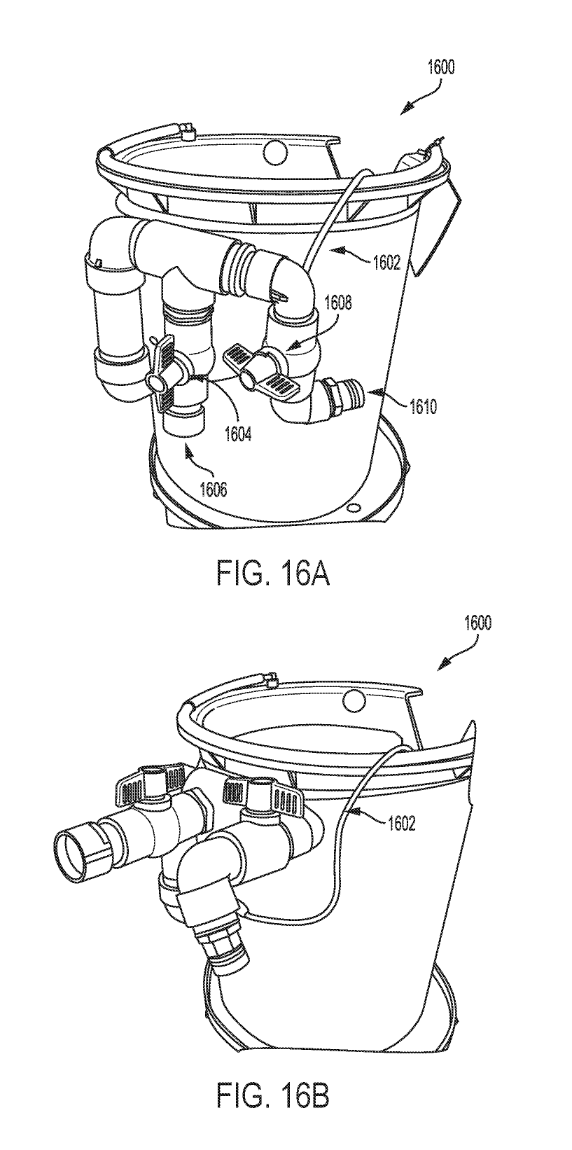

FIGS. 16A and 16B show another example skimmer basin 1600 with plumbing 1602 coupled to an outside of the skimmer basin 1600. The plumbing 1602 includes a first valve 1604 configured to control a flow to a pond diverter outlet 1606. The plumbing 1602 also includes a second valve 1608 configured to control a flow to a recirculation outlet 1610. The first valve 1604 and pond diverter outlet 1606 may allow the attachment of a first hose that leads to a different area of the pond, such as a waterfall area, stream feature, or upper pool. The second valve 1608 and recirculation outlet 1610 may allow water to be introduced back into the pond, or to a location outside of the pond, such as an aquaponics grow station or other use for nutrition-rich pond water. Water provided to such an external feature may flow back to the pond in a different pathway (e.g. another hose), thus recirculating the water back into the pond. The second valve 1608 also may act as a “tuner” valve that allows adjustment of a flow of water from the pond diverter outlet 1606. For example, the second valve 1608 may be entirely closed to divert water out of the pond divert outlet 1606, or opened partially or fully to vary the distribution of flow between the diverter outlet 1606 and recirculation outlet 1610. In these examples and others, the flow distribution may allow the skimmer pump to draw in water at its maximum capacity through the upper opening while circulating the water out through the pond diverter outlet 1606 and/or the recirculation outlet 1610. The recirculation outlet 1610 further may allow the attachment of a clean-out hose for pond cleaning. In such a configuration, the first valve 1604 is closed while the second valve 1608 is open, such that water is pumped out of the pond, after which the pond may be pumped down. As shown at FIG. 16B, the plumbing componentry 1602 may be configured to swing out from a side of the skimmer basin 1600 to allow for easy access when needed, e.g. during install or when changing between the configurations described above.

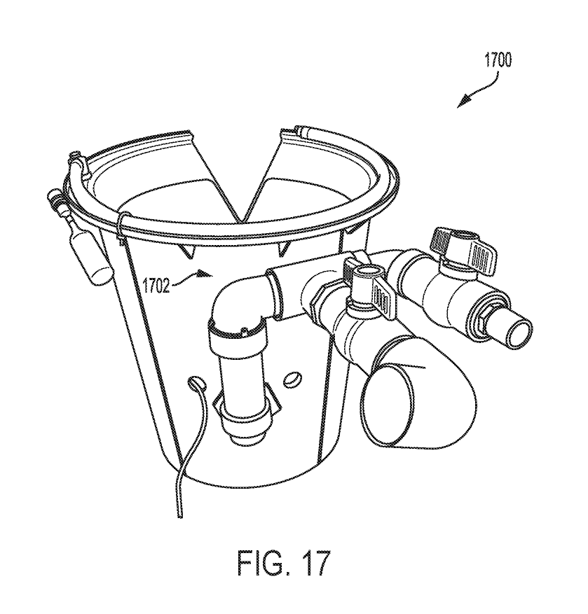

FIG. 17 shows another example skimmer basin 1700 with a different configuration of plumbing componentry 1702 coupled to an outside of the skimmer basin 1700. As shown, the plumbing componentry 1702 also may be configured to pivot away from the skimmer basin 1700 to allow for easy access when needed, e.g. during install.

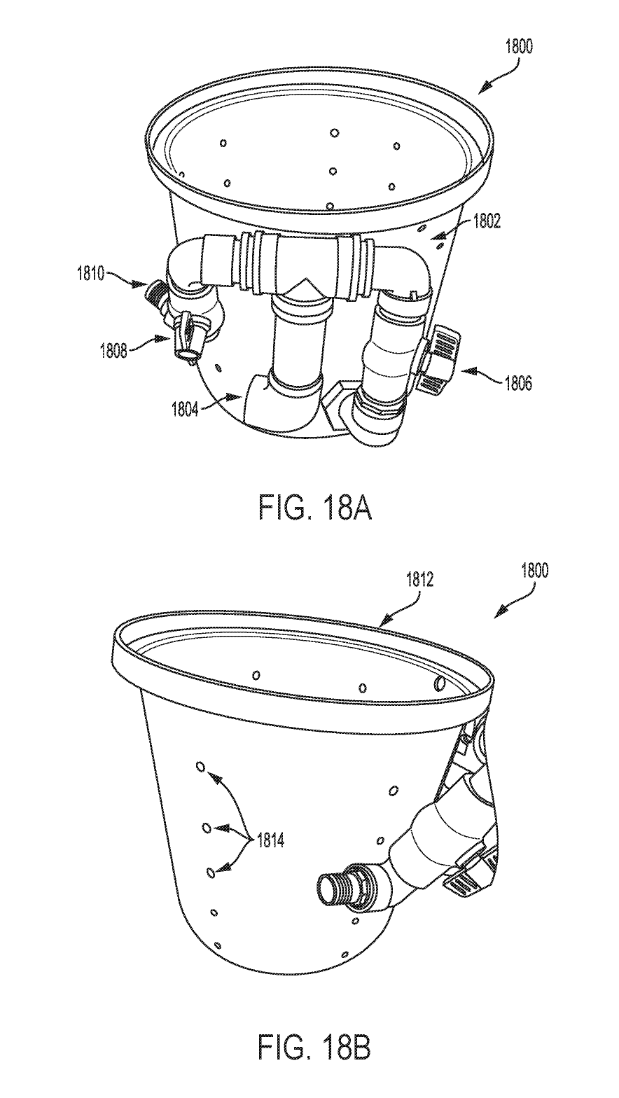

FIGS. 18A and 18B show another example filter basin 1800, and illustrate another example configuration of an inflow component 1802 coupled to an outside of the filter basin 1800. The inflow component 1802 includes an inlet 1804 configured to receive pond water pumped by an in-pond pump, a first valve 1806 configured to adjust a flow of water leading inside the filter basin 1800, and a second valve 1808 coupled to a recirculation outlet 1810. When opened, the first valve 1806 allows water from the pond to run inside and up through the filter basin 1800. The second valve 1808 may simultaneously be opened with a hose attached to the recirculation outlet 1810. Water that is pumped through the recirculation outlet 1810 may flow back into the pond, or to an external feature, such as an aquaponics grow station. In another configuration, the first valve 1806 may be closed while the second valve 1808 remains open e.g. during a pond pump down and clean-out process. In such a process, a clean-out hose may be attached to the recirculation outlet 1810 and the filter basin 1800 may then be back-rinsed.

The filter basin 1800 is depicted as being lidless, such that water flowing through inside the filter basin 1800 may flow upward and out of the open top 1812 of the filter basin 1800, rather than through outflow openings within a lid. FIG. 18B shows a plurality of side openings 1814 formed in a side of the filter basin 1800. As mentioned above, when the filter basin 1800 is placed under water level, static pressure at the side openings 1814 allows water to flow in an upward direction through the filter basin 900 and out through the open top 1812, rather than outward through the side openings 1814.

FIGS. 19A and 19B show an example sump pump basin 1900 for housing a sump pump 1902 when installed in a pond. Sump pump 1902 may be positioned in a suitable sump area of the pond and be configured to pump pond water up to a filter basin via a hose, as in the manner of sump pump 116 described above. An outlet 1904 of the sump pump 1902 may allow attachment of a hose that leads up to a filter basin. A lid (not shown) may cover a top of the sump pump basin 1900. The sump pump 1902 may draw pond water in through a plurality of side openings 1908 formed in a side of the sump pump basin 1900. Rocks may be placed surrounding the outside of the sump pump basin 1900 to provide camouflage and additional water filtration. Additionally, filter media may also be placed inside the sump pump basin 1900, such that water is filtered twice, once by the filter media outside and again by the inside filter media.

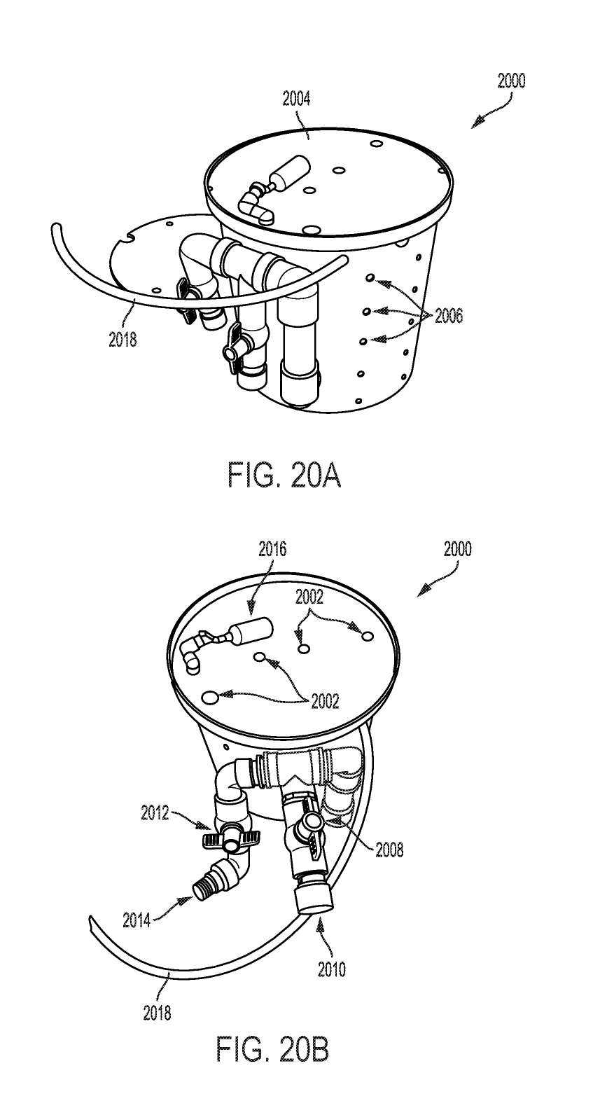

FIGS. 20A and 20B show another example pondless filter pump basin 2000 for use in a pondless water feature. Pondless filter pump basin 2000 includes a pump situated inside the basin 2000 that is configured to draw water in through openings 2002 in a lid 2004 covering the basin 2000 and/or through side openings 2006 formed in a side of the basin 2000. Water from the pondless water feature may be filtered by rocks surrounding the filter pump basin 2000 and/or pump inside filter pump basin 2000. Plumbing componentry on the outside of the filter pump basin 2000 includes a first valve 2008 configured to allow water to be pumped out through channel 2010 when opened via an attachable hose that leads up to the top of a fountain, rock column, stream, or upper portion of any suitable pondless water feature. The filter pump basin 2000 further includes a second valve 2012 configured to adjust an amount of water flowing out through recirculation outlet 2014. Second valve 2012 may act as a “tuner” valve to adjust the amount of water flowing to the upper portion of the pondless water feature. For example, the second valve may be entirely closed to allow pumped water to flow out via channel 2010, entirely opened to allow water to flow both out of the channel 2010 and the recirculation outlet 1610 (e.g. back into the surrounding water), or adjusted to vary the flow distribution as desired.

Similar to that of FIGS. 18 and 19, recirculation outlet 2014 may further allow the attachment of a hose that leads to an aquaponics grow station or similar. Further, recirculation outlet 2014 may also allow attachment of a clean-out hose for pumping the pond down and cleaning out the filter pump basin 2000, in which case the first valve 2008 is closed and the second valve 2012 is opened. The filter pump basin 2000 further includes a float valve 2016 for auto-fill and a float valve supply hose 2018 connecting to the float valve 2016.

The subject matter of the present disclosure includes all novel and non-obvious combinations and sub-combinations of the various processes, systems and configurations, and other features, functions, acts, and/or properties disclosed herein, as well as any and all equivalents thereof.

1. A pond water quality maintenance system, comprising:
a skimmer basin configured to collect pond surface debris, the skimmer basin comprising
an upper opening configured to permit a flow of water and debris from a pond surface into the skimmer basin,
a strainer basket positioned within the skimmer basin and configured to trap at least some of the debris that enters the skimmer basin through the upper opening,
a skimmer pump positioned within the skimmer basin below the strainer basket, the skimmer pump configured to draw water through the strainer basket and to pump the water out of the skimmer basin, and
one or more lower openings configured to permit a flow of water into the skimmer basin from a pond depth below the strainer basket.

2. The pond water quality maintenance system of claim 1, further comprising a debris collection pad positioned above the strainer basket.

3. The pond water quality maintenance system of claim 1, further comprising a pump screen surrounding an inlet of the skimmer pump, the pump screen being configured to filter water at an intake of the skimmer pump.

4. The pond water quality maintenance system of claim 1, further comprising a flow adjustment valve configured to receive water pumped by the skimmer pump and to set a flow rate out of the skimmer basin.

5. The pond water quality maintenance system of claim 4, wherein the flow adjustment valve is configured to pivot with respect to a side of the skimmer basin.

6. The pond water quality maintenance system of claim 1, further comprising a float valve coupled to the skimmer basin and located outside of the skimmer basin.

7. The pond water quality maintenance system of claim 1, wherein the upper opening comprises a notch formed in a side of the skimmer basin.

8. The pond water quality maintenance system of claim 1, wherein the skimmer basin further comprises a flange extending outwardly from a top of the skimmer basin.

9. The pond water quality maintenance system of claim 1, further comprising one or more supporting elements located within the skimmer basin and configured to support the strainer basket at a position higher than the one or more lower openings in the skimmer basin.

10. A pond filter system, comprising:
a filter basin having an outflow opening; and
an inflow component coupled to the filter basin, the inflow component comprising
an inlet located outside of the filter basin, the inlet configured to receive a flow of pond water from a pump,
an outlet positioned within the filter basin at a lower location in the filter basin than the outflow opening of the filter basin, and
a bypass outlet positioned outside of the filter basin to permit a portion of the pond water received from the pump to bypass the filter basin.

11. The pond filter system of claim 10, further comprising filter media located between the outlet of inflow component and the outflow opening of filter basin.

12. The pond filter system of claim 10, further comprising a removable lid positioned over the filter basin, and wherein the outflow opening of the filter basin comprises one or more holes formed in the removable lid.

13. The pond filter system of claim 10, further comprising one or more drain openings formed in a lower portion of the filter basin.

14. The pond filter system of claim 10, wherein the inflow component further comprises a flow distributor attached to the outlet, the flow distributor configured to be removable from the outlet.

15. The pond filter system of claim 14, wherein the outlet is configured to be coupled to a pump when the flow distributor is removed.

16. The pond filter system of claim 10, wherein the bypass outlet is configured to connect to a hose for cleanout.

17. A pond water quality maintenance system, comprising:
a first recirculation path, the first recirculation path comprising
a skimmer basin configured to collect pond surface debris, the skimmer basin comprising
an upper opening configured to permit a flow of water and debris into the skimmer basin from a pond surface,
a strainer basket positioned within the skimmer basin and configured to trap at least some of the debris that enters the skimmer basin through the upper opening, and
a skimmer pump positioned within the skimmer basin below the strainer basket, the skimmer pump configured to draw water through the strainer basket and the lower openings simultaneously, and to pump the water out of the skimmer basin; and
a second recirculation path, the second recirculation path comprising
a sump pump located in a bottom portion of a pond, and
a filter basin located in the bottom portion of the pond, the filter basin comprising an inlet configured to receive a flow of pond water from the sump pump, and an outflow opening.

18. The pond water quality maintenance system of claim 17, wherein the skimmer basin further comprises one or more lower openings configured to permit a flow of water into the skimmer basin from a pond depth below the strainer basket.

19. The pond water quality maintenance system of claim 17, wherein the skimmer basin further comprises a pump screen surrounding an inlet of the skimmer pump, the pump screen being configured to filter water at an intake of the skimmer pump.

20. The pond water quality maintenance system of claim 17, wherein the filter basin further comprises an inflow component comprising an inlet located outside of the filter basin and an outlet positioned within the filter basin at a lower location in the filter basin than the outflow opening of the filter basin, the outlet of the inflow component being configured to introduce pond water received from the sump pump into a lower portion of the filter basin.

21. The pond water quality maintenance system of claim 17, wherein the filter basin further comprises filter media located between the outlet of inflow component and the outflow opening of filter basin.
